(19) United States
(12) Patent Application Publication
(10) Pub. No.: US 2010/0004941 A1
(43) Pub. Date: Jan. 7, 2010

(54) Method and Apparatus for Generating Customized Provisioning Workflows from One Flow Models

(75) Inventors: Huang-Yang Chang, Scarsdale, NY (US); Santhosh Babu Kumaran, Peekskill, NY (US); Sreeram Ramakrishnan, Yorktown Heights, NY (US); Debanjan Saha, Mohegan Lake, NY (US)

Correspondence Address: CAHN & SAMUELS, LLP, 1100 17th STREET, NW, SUITE 401, WASHINGTON, DC, 20036, US

(73) Assignee: INTERNATIONAL BUSINESS MACHINES CORPORATION, Armonk, NY (US)

(21) Appl. No.: 12/167,166

(22) Filed: Jul. 2, 2008

(51) Int. Cl. G06Q 10/00

(52) U.S. Cl. 705/1

(57) ABSTRACT

A method and apparatus for provisioning customized information technology (IT) service workflows based on selection and concatenation. The method and apparatus matches tasks required to fulfill service requests to existing models and creates alternative service models to perform similar requests. The method and apparatus enables the development of customized run-time workflow and service task artifacts in response to information technology (IT) service requests based on selection and concatenation such that known and alternative workflows are quickly and reliably provisioned. The customized workflows are also compliant with process optimization methods such as Lean Six Sigma, Kaizen and others.

### I. FIELD OF THE INVENTION

This invention relates generally to a method and apparatus for provisioning customized information technology (IT) service workflows based on selection and concatenation. Specifically, the present invention relates to a method and apparatus that matches tasks required to fulfill service requests to existing models and creates alternative service models to perform similar requests.

### II. BACKGROUND OF THE INVENTION

In an information technology (IT) service delivery environment, it is often necessary to be able to quickly and reliably generate customized run time workflows and service tasks artifacts in response to a service request. A template based approach is one process that has been used to perform these functions. The template based approach typically assumes a corresponding one-to-one match between the service request being considered and the existing process templates. However as expected, given the variability in the domain and the level of customization required for each request a match cannot always be expected. The generated workflows and artifacts must also be compliant with process optimization methods.

Another critical issue with template-based information technology (IT) service delivery is the associated limitations with respect to the ability to generate alternative service workflows during the provisioning phase. This limitation is made even more critical from the perspective of real-time process control. For example, when assumptions regarding resource or tool availability changes during the execution of a process, the inability of template based processes to quickly identify an alternate set of tasks that can accomplish the same objective threaten the usefulness of the entire process.

### III. SUMMARY OF THE INVENTION

In at least one embodiment, the present invention provides a method including receiving at least one service request; extracting information from said at least one service request; selecting business model candidates for said at least one service request; searching a database for business models that match said at least one service request, wherein said business models include process templates for provisioning said at least one service request; and generating service tasks for said process templates.

In at least another embodiment, the present invention provides a system, including means for receiving at least one service request; means for extracting information from said at least one service request; means for selecting business model candidates for said at least one service request; means for searching a database for business models that match said at least one service request, wherein said business models include process templates for provisioning said at least one service request; and means for generating service tasks for said process templates.

In at least another embodiment, the present invention provides a computer program product comprising a computer useable medium including a computer readable program, wherein the computer readable program when executed on a computer causes the computer to receive at least one service request; extract information from said at least one service request; select business model candidates for said at least one service request; search a database for business models that match said at least one service request, wherein said business models include process templates for provisioning said at least one service request; and generate service tasks for said process templates.

In at least another embodiment, the present invention provides a method including receiving at least one service request; extracting information from said at least one service request; selecting business model candidates for said at least one service request; searching a database for business models that match said at least one service request, wherein said business models include process templates for provisioning said at least one service request; generating service tasks for said process templates generating at least one service request for said service tasks; generating a service plan for said at least one service request; and generating at least one service order task for said service plan.

In at least one embodiment, the present invention provides a method and apparatus that enable customized run-time workflow and service task artifacts to be developed in response to information technology (IT) service requests based on selection and concatenation such that known and alternative workflows are quickly and reliably provisioned, as well as being compliant with process optimization methods such as Lean Six Sigma, Kaizen and others.

### IV. BRIEF DESCRIPTION OF THE DRAWINGS

The present invention is described with reference to the accompanying drawings, wherein:

FIG. 1 illustrates an overview of an exemplary embodiment of the present invention.

FIGS. 2A-2B illustrate an OFM selection process of an exemplary embodiment of the present invention.

FIG. 3 illustrates an OFM selection process of an exemplary embodiment of the present invention.

FIG. 4 illustrates a service task generation process of an exemplary embodiment of the present invention.

Given the following enabling description of the drawings, the apparatus should become evident to a person of ordinary skill in the art.

### V. DETAILED DESCRIPTION OF THE DRAWINGS

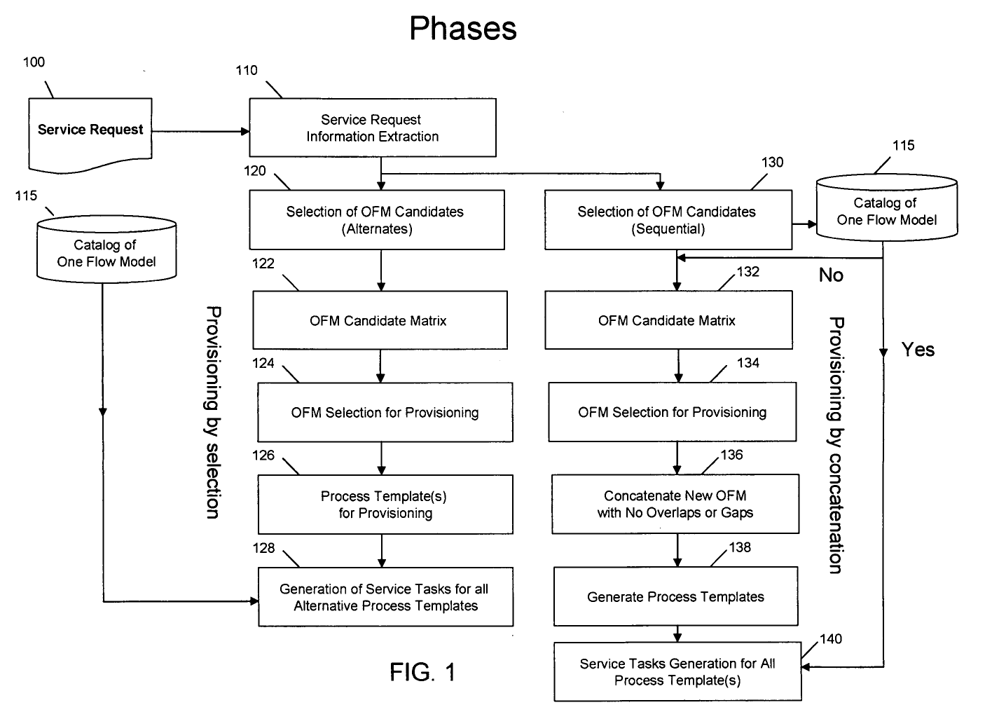

The present invention will be described in an information technology (IT) services environment and its advantages are best understood by referring to FIGS. 1-5. The present invention provides provisioning techniques—provisioning by selection and provisioning by concatenation—that allow for the development of customized run time service workflows and task artifacts. The present invention, at least one exemplary embodiment, utilizes business process models to provide service workflows and task artifacts that are compliant with process improvement techniques, such as, but not limited to, Lean Six Sigma, Kaizen, and others (collectively “lean” techniques). While the present invention is described with respect to One Flow Model (OFM) business process representations that maintain compliance with OFMs, it is not intended to be limited for use with OFMs, as other similar process models are within the scope of the disclosure.

The process of provisioning by selection provides one or more alternative OFM candidates that are “selected” based on the proximity of the match between the request and the candidate. In provisioning by selection, a service request is characterized with a representation, e.g., a feature vector, using a pre-defined sub-set of attributes such as configurations, tools, platforms, skill levels, database types, and/or any other user-defined specifications or requirements. The system accesses a database of stored OFMs in an attempt to find an OFM that matches the service request. The feature vector used to characterize the service request is similar to the feature vectors used to define the OFM models. The feature vector allows users to prioritize the attributes and forms the basis of the comparison of the service request with OFMs stored in a database such as a catalog. When no perfect match is available, a search algorithm enables the user to identify the closest matching OFMs (or candidate OFMs) based on the criteria specified in the feature vector. Based on domain knowledge, a sub-set of these candidate OFMs can then be selected for defining process templates for the specific service request. The associated process template is generated for each of the chosen OFMs. This set of alternate process templates enables the generation of service tasks. These alternate sets of concatenated service tasks (the provisioned service request) can be used for real-time decision making with respect to process control, as they represent alternative courses of action for a particular service request.

The process of provisioning by concatenation generates process templates for a service request by horizontally (or sequentially) integrating various OFMs. In provisioning by concatenation, the OFMs are integrated such that any overlapping service tasks are removed. Any atomic/composite service(s) needed to complete the end-to-end process may then be added for provisioning of the service request. Similar to provisioning by selection, a feature vector is generated to characterize the service request. However, in provisioning by concatenation, this feature vector may be defined to identify differently weighted feature vectors. These feature vectors provide the potential for identifying different OFMs for generating process templates needed for the service requests. Dominant components of the OFMs are identified for each phase of the service request. These dominant components may be identified by utilizing computational probability techniques such as Ant Colony Optimization (ACO) algorithms. These OFM choices for each process phase may be further narrowed by the user to construct a preliminary set on concatenated OFM phases (after removing any overlapping composite service tasks). A semi-automated inspection of the alternate OFMs is then performed to add any composite services needed to fill any voids in the end-to-end process associated with the service request. The alternate OFMs obtained are then capable of serving as process templates for provisioning the request.

FIG. 1 illustrates an overview of an example of the method of the present invention. The present invention begins the process of selecting candidate OFMs by receiving a service request at 100. At 110, the method extracts information, e.g., attributes used to define a feature vector, from the service request. The system then proceeds to utilize both provisioning techniques, i.e., provisioning by selection and provisioning by concatenation, for each service request. The initial steps involved for provisioning by selection and provisioning by concatenation are functionally equivalent but involve different processes. In the first provisioning method, provisioning by selection, the user can check for the existence of any OFM(s) that match the service request requirements. In the second provisioning method, provisioning by concatenation, the method attempts to identify portions of OFM(s) that are deemed appropriate for provisioning certain segments of the service request. In this method, instead of entire OFMs certain OFM segments (as defined by composite services) are identified as appropriate for provisioning particular segments of the service request. A user may choose either one or both provisioning methods as a starting point to select the OFM that forms the basis for the service task generator.

In an example of the method, provisioning by selection begins at 120 by selecting various alternate OFM candidates. At 120, the method also accesses catalog 115 to determine if there is a single OFM that is a perfect match for the service request. If there is a matching OFM for the request in catalog 115, the method proceeds to 128 and generates service tasks for all alternative process templates for the OFM. If there is not a matching OFM for the request in catalog 115, the method proceeds to 122. At 122, the method generates a matrix of OFM candidates. At 124, the method selects candidate OFMs from the matrix for provisioning. At 126, the method provides process template(s) for provisioning the service request. At 128, the method generates service tasks for all alternative process templates.

Provisioning by concatenation begins at 130 by selecting various sequential OFM candidates. At 130, the method also accesses catalog 115 to determine if there are matching OFMs for the service request. If there are matching OFMs for the service request, the method proceeds to 140 and generates service tasks for all process templates. If there are no matching OFMs for the service request in catalog 115, the method proceeds to 132 and generates a matrix of candidate OFMs. At 134, the method selects candidate OFMs from the matrix for provisioning. At 136, the method concatenates the OFMs so that no overlaps or gaps exist in the tasks related to said sequential business model candidates. At 138, the method generates process template(s) for provisioning the service request. At 140, the method generates service tasks for all process template(s).

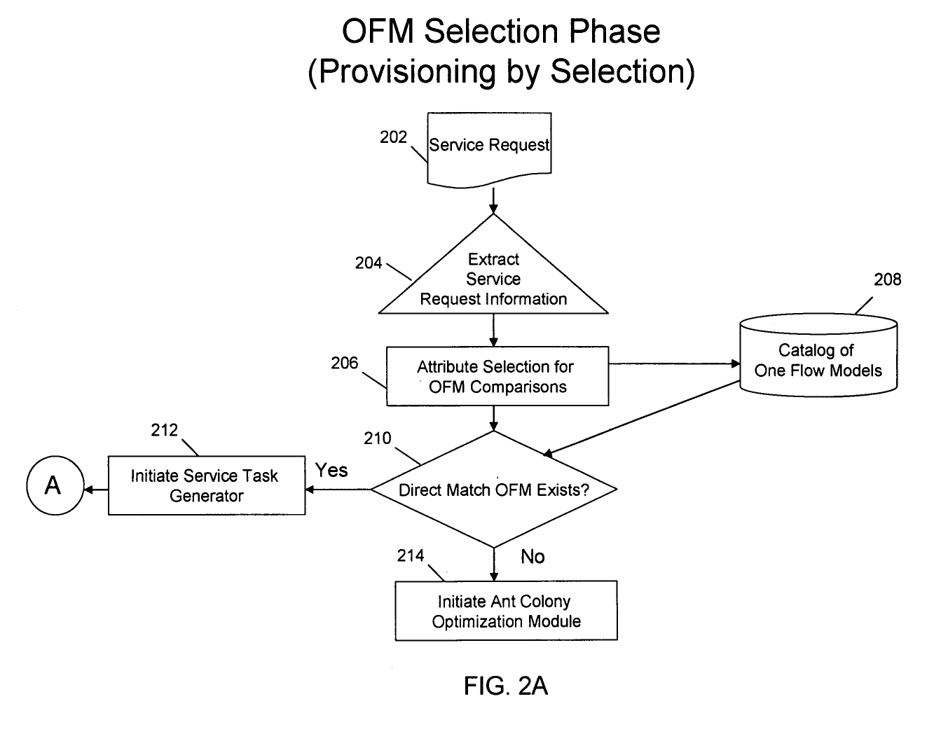

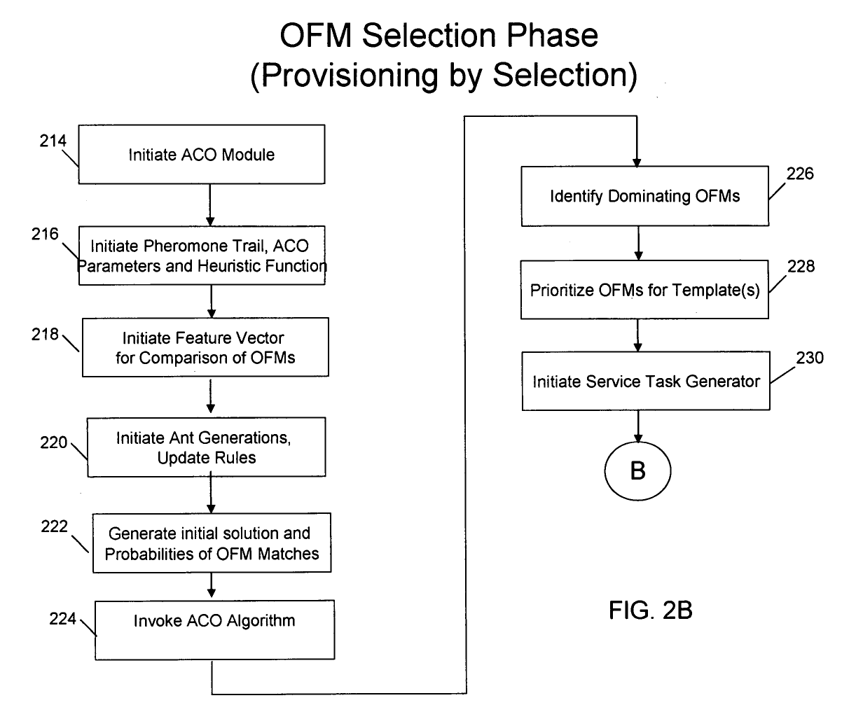

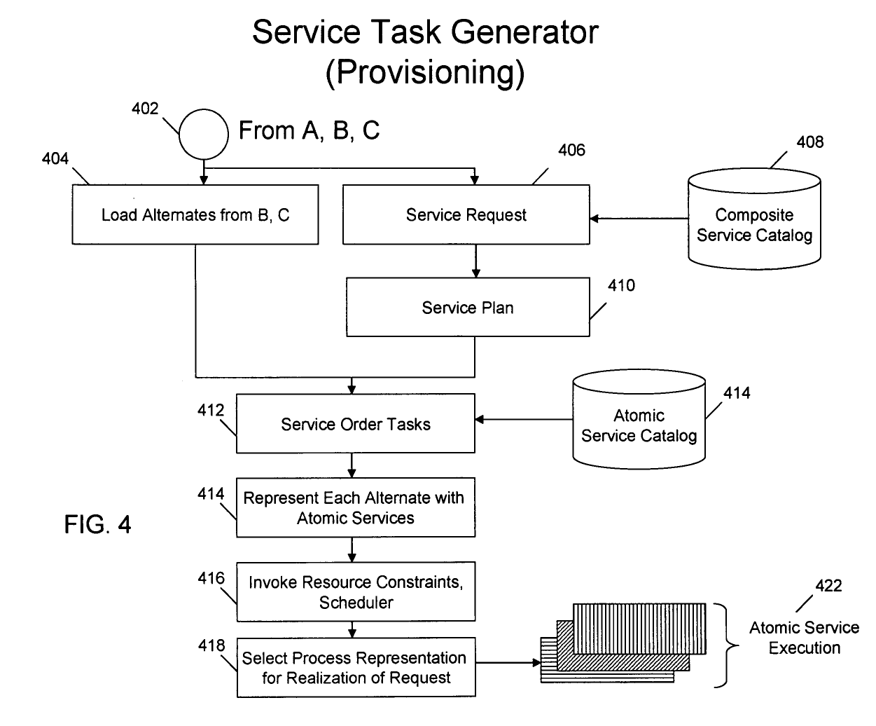

FIGS. 2A-2B illustrate an exemplary OFM selection procedure of the provisioning by selection phase of the method outlined in FIG. 1. The OFM selection procedure begins at 202 with a service request. At 204, information, such as attributes and keywords related to the service request, is extracted from the service request. At 206, the method selects attributes and keywords from the extracted information are selected for comparison with stored OFMs. At 208, selected attributes and keywords are compared with stored OFMs to determine if any “close” OFMs exist. At 210, the method determines whether an OFM that matches the attributes exists. This may be an automated search that ranks the matches, e.g., based on percentage or strength of match. If Yes, the method proceeds to 212 and initiates a service task generator. Service tasks A are output for provisioning, as discussed below with respect to FIG. 4. If No, the method proceeds to 214 and initiates an Ant Colony Optimization (ACO) Module.

ACO is a meta-heuristic approach often applied to various NP hard problems in both static and dynamic combinatorial optimizations such as scheduling, routing, sequential ordering and graph coloring. First, the heuristic function consisting of two components need to be defined—exploitative and biased exploration. This function is the proxy for the fitness of a particular OFM to the service request being considered. Global update rules helps the ants to arrive at a solution that minimizes errors which in this context may be the cost of a wrong match to an OFM. Local update rules helps ants to discard any OFMs that are not suitable while also allowing the ants to consider OFMs that were not previously considered. The ant colony parameters are then set. These parameters include the number of ants, exploitation probability factor, pheromone update strength parameter, and the pheromone decay parameter. The solution obtained by the algorithm yields the best matching subset of OFMs from the catalog for a specific service request. This match may be based on a specified minimum threshold level. Further, during the execution of the algorithm if update cycle yields an OFM with a high match, e.g., 90% or higher, the user has the option of terminating the process.

The process continues in FIG. 2B at 214. At 216, pheromone trail, ACO parameters and heuristic functions are initiated. At 218, feature vectors are initiated for comparison of OFMs. At 220, ant generations are initiated and rules are updated. At 222, initial solution and probabilities of OFM matches are generated. At 224, the ACO algorithm is invoked. At 226, dominating OFMs are identified. At 228, OFMs for template(s) are prioritized. At 230, the service task generator is initiated and service tasks B are output for provisioning, as discussed below with respect to FIG. 4.

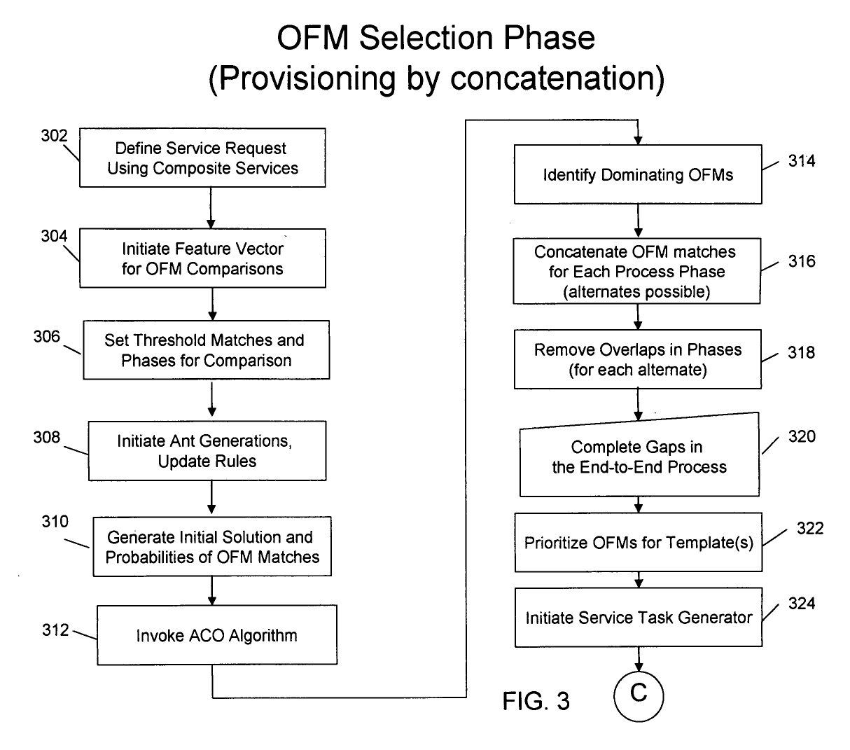

FIG. 3 illustrates an exemplary OFM selection procedure of the provisioning by concatenation phase of the method outlined in FIG. 1. The OFM selection procedure begins at 302 and utilizes composite services to define the service request. At 304, feature vectors are initiated for comparison of OFMs. At 306, threshold matches and phases are set for comparison. At 308, ant generations are initiated and rules are updated. At 310, initial solution and probabilities of OFM matches are generated. At 312, the ACO algorithm is invoked. At 314, dominating OFMs are identified. At 316, OFM matches are concatenated for each process phase including all possible alternate OFMs. At 318, any overlaps in phase are removed for each alternate OFM. At 320, gaps are completed in the end-to-end process. At 322, OFMs for template(s) are prioritized. At 324, the service task generator is initiated and service tasks C are output for provisioning, as discussed below with respect to FIG. 4.

FIG. 4 illustrates an exemplary service task generation process for the method outlined in FIG. 1. At 402, outputs A and B from the provisioning by selection phase (shown in FIGS. 2A-2B) and output C from the provisioning by concatenation phase (shown in FIG. 3) are received. At 404, alternate OFMs from B and C are loaded. At 406, service request are matched with composite OFMs from the composites service catalog 408. At 410, a service plan is generated. At 412, service order tasks are generated utilizing atomic services from the atomic services catalog 414. At 416, each alternate OFM is represented with atomic services. At 418, resource constraints and scheduler is invoked. At 420, the process representation for performing the request is selected. At 422, atomic services are output for execution.

The invention can take the form of an entirely hardware embodiment, an entirely software embodiment or an embodiment containing both hardware and software elements. In at least one exemplary embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As will be appreciated by one of ordinary skill in the art, the present invention may be embodied as a computer implemented method, a programmed computer, a data processing system, a signal, and/or computer program. Accordingly, the present invention may take the form of an entirely hardware embodiment, an entirely software embodiment or an embodiment combining software and hardware aspects. Furthermore, the present invention may take the form of a computer program on a computer-usable storage medium having computer-usable program code embodied in the medium. Any suitable computer readable medium may be utilized including hard disks, CD-ROMs, optical storage devices, carrier signals/waves, or other storage devices.

Computer program code for carrying out operations of the present invention may be written in a variety of computer programming languages. The program code may be executed entirely on at least one computing device, as a stand-alone software package, or it may be executed partly on one computing device and partly on a remote computer. In the latter scenario, the remote computer may be connected directly to the one computing device via a LAN or a WAN (for example, Intranet), or the connection may be made indirectly through an external computer (for example, through the Internet, a secure network, a sneaker net, or some combination of these).

It will be understood that each block of the flowchart illustrations and block diagrams and combinations of those blocks can be implemented by computer program instructions and/or means. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowcharts or block diagrams.

The exemplary and alternative embodiments described above may be combined in a variety of ways with each other. Furthermore, the steps and number of the various steps illustrated in the figures may be adjusted from that shown.

It should be noted that the present invention may, however, be embodied in many different forms and should not be construed as limited to the embodiments set forth herein; rather, the embodiments set forth herein are provided so that the disclosure will be thorough and complete, and will fully convey the scope of the invention to those skilled in the art. The accompanying drawings illustrate exemplary embodiments of the invention.

Although the present invention has been described in terms of particular exemplary and alternative embodiments, it is not limited to those embodiments. Alternative embodiments, examples, and modifications which would still be encompassed by the invention may be made by those skilled in the art, particularly in light of the foregoing teachings.

Those skilled in the art will appreciate that various adaptations and modifications of the exemplary and alternative embodiments described above can be configured without departing from the scope and spirit of the invention. Therefore, it is to be understood that, within the scope of the appended claims, the invention may be practiced other than as specifically described herein.

We claim:

1. A method, comprising:
receiving at least one service request;
extracting information from said at least one service request;
selecting business model candidates for said at least one service request;
searching a database for business models that match said at least one service request, wherein said business models include process templates for provisioning said at least one service request; and
generating service tasks for said process templates.

2. The method according to claim 1, wherein selecting business model candidates for said at least one service request includes selecting alternative business model candidates and selecting sequential business model candidates when no matching business models are found in said database.

3. The method according to claim 2, wherein selecting alternative business model candidates includes:
generating a matrix of said business model candidates, wherein said matrix includes alternative business model candidates;
selecting business model candidates from said matrix for provisioning said at least one service request;
providing alternative process templates for provisioning said at least one service request; and
generating service tasks for said alternative process templates.

4. The method according to claim 3, wherein feature vectors are utilized to select said business model candidates from said matrix of business models.

5. The method according to claim 3, wherein said matrix of business model candidates is generated utilizing an ant colony optimization process.

6. The method according to claim 2, wherein selecting sequential business model candidates includes:
generating a matrix of said business model candidates, wherein said matrix includes sequential business model candidates;
selecting business model candidates from said matrix for provisioning said at least one service request;
concatenating new business models from said matrix, wherein said new business models have no overlaps or gaps in tasks related to said sequential business model candidates;
generating process templates for provisioning said service request; and
generating service tasks for said alternative process templates.

7. The method according to claim 6, wherein feature vectors are utilized to select said business model candidates from said matrix of said business model candidates.

8. The method according to claim 6, wherein said matrix of business model candidates is generated utilizing an ant colony optimization process.

9. The method according to claim 1, further comprising:
generating at least one service request for said service tasks;
generating a service plan for said at least one service request; and
generating at least one service order task for said service plan.

10. The method according to claim 9, further comprising:
utilizing composite services to fulfill said service request; and
utilizing atomic services to fulfill said service plan.

11. A system, comprising:
means for receiving at least one service request;
means for extracting information from said at least one service request;
means for selecting business model candidates for said at least one service request;
means for searching a database for business models that match said at least one service request, wherein said business models include process templates for provisioning said at least one service request; and
means for generating service tasks for said process templates.

12. The system according to claim 11, wherein said means for selecting business model candidates for said at least one service request further includes:
means for selecting alternative business model candidates and means for selecting sequential business model candidates when no matching business models are found in said database.

13. The system according to claim 12, wherein said means for selecting alternative business model candidates further includes:
means for generating a matrix of said business model candidates, wherein said matrix includes alternative business model candidates;
means for selecting business model candidates from said matrix for provisioning said at least one service request;
means for providing alternative process templates for provisioning said at least one service request; and
means for generating service tasks for said alternative process templates.

14. The system according to claim 12, wherein said means for selecting sequential business model candidates further includes:
means for generating a matrix of said business model candidates, wherein said matrix includes sequential business model candidates;
means for selecting business model candidates from said matrix for provisioning said at least one service request;
means for concatenating new business models from said matrix, wherein said new business models have no overlaps or gaps in tasks related to said sequential business model candidates;
means for generating process templates for provisioning said service request; and
means for generating service tasks for said alternative process templates.

15. The system according to claim 11, further comprising:
means for generating at least one service request for said service tasks;
means for generating a service plan for said at least one service request; and
means for generating at least one service order task for said service plan.

16. A computer program product comprising a computer useable medium including a computer readable program, wherein the computer readable program when executed on a computer causes the computer to:
receive at least one service request;
extract information from said at least one service request;
select business model candidates for said at least one service request;
search a database for business models that match said at least one service request, wherein said business models include process templates for provisioning said at least one service request; and
generate service tasks for said process templates.

17. A computer program product according to claim 15, wherein when no matching business models are found in said database the computer readable program to cause the computer to:
select alternative business model candidates, and
select sequential business model candidates.

18. A computer program product according to claim 16, wherein the computer readable program further causes the computer to:
generate a matrix of said business model candidates, wherein said matrix includes alternative business model candidates;
select business model candidates from said matrix for provisioning said at least one service request;
provide alternative process templates for provisioning said at least one service request; and
generate service tasks for said alternative process templates.

19. A computer program product according to claim 16, wherein the computer readable program further causes the computer to:
generate a matrix of said business model candidates, wherein said matrix includes sequential business model candidates;
select business model candidates from said matrix for provisioning said at least one service request;
concatenate new business models from said matrix, wherein said new business models have no overlaps or gaps in tasks related to said sequential business model candidates;
generate process templates for provisioning said service request; and
generate service tasks for said alternative process templates.

20. A computer program product according to claim 16, wherein the computer readable program further causes the computer to:
generate at least one service request for said service tasks;
generate a service plan for said at least one service request; and
generate at least one service order task for said service plan.

21. A method, comprising:
receiving at least one service request;
extracting information from said at least one service request;
selecting business model candidates for said at least one service request;
searching a database for business models that match said at least one service request, wherein said business models include process templates for provisioning said at least one service request;
generating service tasks for said process templates generating at least one service request for said service tasks;
generating a service plan for said at least one service request; and
generating at least one service order task for said service plan.

22. The method according to claim 21, wherein selecting business model candidates for said at least one service request includes selecting alternative business model candidates and selecting sequential business model candidates when no matching business models are found in said database.

23. The method according to claim 22, wherein selecting alternative business model candidates includes:
generating a matrix of said business model candidates, wherein said matrix includes alternative business model candidates;
selecting business model candidates from said matrix for provisioning said at least one service request;
providing alternative process templates for provisioning said at least one service request; and
generating service tasks for said alternative process templates.

24. The method according to claim 22, wherein selecting sequential business model candidates includes:
generating a matrix of said business model candidates, wherein said matrix includes sequential business model candidates;
selecting business model candidates from said matrix for provisioning said at least one service request;
concatenating new business models from said matrix, wherein said new business models have no overlaps or gaps in tasks related to said sequential business model candidates;
generating process templates for provisioning said service request; and
generating service tasks for said alternative process templates.
